(19) United States
(12) Patent Application Publication
(10) Pub. No.: US 2008/0113122 A1
(43) Pub. Date: May 15, 2008

(54) Optical film, method of manufacturing optical film and liquid crystal display device having the same

(75) Inventors: Jeong Min Moon, Gyeonggi-do (KR); Byung Hwa Ji, Gyeonggi-do (KR)

Correspondence Address: SEYFARTH SHAW, LLP, 815 CONNECTICUT AVENUE, N.W., SUITE 500, WASHINGTON, DC, 20006, US

(73) Assignee: LG.PHILIPS LCD CO., LTD., Seoul (KR)

(21) Appl. No.: 11/797,324

(22) Filed: May 2, 2007

(30) Foreign Application Priority Data
Nov. 10, 2006 (KR) 10-2006-0110787

(51) Int. Cl. C09K 19/00; B29D 7/01

(52) U.S. Cl. 428/1.61; 264/1.34; 428/1.1; 428/1.62

(57) ABSTRACT

An optical film includes a multi-layer sheet having a plurality of polyethylene terephthalate polymer layers, the polymer layers having a first refraction index in a first direction parallel to a plane of the polymer layers and a second refraction index in a second direction parallel to the plane of the polymer layers, and a plurality of polyethylene terephthalate copolymer layers, the copolymer layers having a third refraction index in both the first and second directions, and a protection sheet directly on at least one side of the multi-layer sheet.

The present application claims the benefits of Korean Patent Application No. 10-2006-0110787 filed in Korea on Nov. 10, 2006, which is hereby incorporated by reference in its entirety.

### BACKGROUND OF THE INVENTION

1. Field of the Invention

Embodiments of the present invention relate to an optical film, and more particularly to a liquid crystal display (LCD) device having the optical film.

2. Description of the Related Art

Generally, a liquid crystal display device includes a thin film transistor substrate, a color filter substrate, a liquid crystal display panel having a liquid crystal layer interposed between the thin film transistor substrate and the color filter substrate, and backlight unit having a separate light source for supplying light to the liquid crystal display panel. The liquid crystal display device includes a polarizer formed on at least one of the top and bottom surfaces of the liquid crystal display panel. The backlight unit includes the light source emitting light and optical films directing the light emitted from the light source toward the top surface of the liquid crystal display panel. The optical films include at least one of a diffusion film, a prism film, and a protection film. Although light emitted from the light source is directed to the polarizer through the optical films, only some of the light having a polarization direction parallel to a transmission axis of the polarizer is transmitted through the polarizer.

Light polarized by the polarizer is incident onto the liquid crystal display panel and is modulated according to the molecular arrangement of the liquid crystal layer of the liquid crystal display panel. Thus, an image can be displayed on a screen of the liquid crystal display device. Other components of the light that are blocked by the polarizer are reflected from the polarizer or absorbed by the polarizer. Therefore, a large portion of light emitted from the light source dose not reach the liquid crystal display panel. As a result, the overall brightness of the backlight is not used, and more power is required for the backlight unit to provide sufficient brightness to the liquid crystal display device.

### SUMMARY OF THE INVENTION

Accordingly, embodiments of the invention are directed to an optical film, a method of manufacturing the optical film, and a liquid crystal display device including the same that substantially obviate one or more problems due to limitations and disadvantages of the related art.

An object of embodiments of the invention is to improve the optical efficiency of a liquid crystal display device, to increase the brightness of the liquid crystal display device, and to reduce the power consumption of a backlight assembly.

An object of embodiments of the invention provides an optical film having enhanced mechanical strength and thermal durability characteristic, and improved light efficiency.

Another embodiment of the invention provides a method for manufacturing an optical film, capable of co-extruding a protection sheet when manufacturing the optical film to integrally form the protection sheet with the optical films without separately attaching the protection sheet on the optical film.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, an optical film includes a multi-layer sheet including: a plurality of polyethylene terephthalate polymer layers, the polymer layers having a first refraction index in a first direction parallel to a plane of the polymer layers and a second refraction index in a second direction parallel to the plane of the polymer layers, and a plurality of polyethylene terephthalate copolymer layers, the copolymer layers having a third refraction index in both the first and second directions, and a protection sheet directly on at least one side of the multi-layer sheet.

In another aspect, an optical film includes a multi-layer sheet including: polymer layers having a first refraction index in a first direction parallel to a plane of the polymer layer and a second refraction index in a second direction parallel to the plane of the polymer layer, and copolymer layers having a third refraction index in both the first and second directions, wherein the polymer layers and the copolymer layers are stacked for transmitting a first component of light incident onto the multi-layer sheet and reflecting a second component of the incident light, and a protection sheet directly on at least one side of the multi-layer sheet.

In another aspect, a method of fabricating an optical sheet includes preparing first, second, and third polymers, melting and extrusion-processing each of the first, second, and third polymers in layered shape, alternately stacking the extrusion-processed first and second polymers in a first feed block, multiplying the number of layers of the first and second polymers in a multiplier, stacking the third polymer directly on at least one side of the stacked first and second polymers in a second feed block, and stretching the stacked first, second and third polymers.

In another aspect, an optical film includes a multi-layer sheet including, a plurality of polymer layers, the polymer layers including polyethylene terephthalate and having a first refraction index in a first stretching direction parallel to a plane of the polymer layers and a second refraction index in a second stretching direction parallel to the plane of the polymer layers, and a plurality of copolymer layers, the copolymer layers including polyethylene terephthalate copolymer and having a third refraction index in both the first and second stretching directions, a protection sheet on at least one side of the multi-layer sheet, and an adhesive member between the multi-layer sheet and the protection sheet.

In another aspect, a liquid crystal display device includes a liquid crystal display panel for displaying images, a reflector for reflecting light, a backlight assembly between the reflector and the liquid crystal panel for irradiating light onto the liquid crystal display panel, and an optical film between the backlight assembly and the liquid crystal panel, the optical film having: a multi-layer sheet including, a plurality of polymer layers, the polymer layers including polyethylene terephthalate and having a first refraction index in a first stretching direction parallel to a plane of the polymer layers and a second refraction index in a second stretching direction parallel to the plane of the polymer layers, and a plurality of copolymer layers, the copolymer layers including polyethylene terephthalate copolymer and having a third refraction index in both the first and second stretching directions, a protection sheet on at least one side of the multi-layer sheet; and an adhesive member between the multi-layer sheet and the protection sheet.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 shows a perspective view of an optical film according to a first embodiment of the invention,;

FIG. 2A shows a side view of the optical film of FIG. 1 in a stretching direction;

FIG. 2B shows a side view of the optical film of FIG. 1 in a non-stretching direction;

FIG. 3 shows a perspective view of an optical film according to a second embodiment of the invention;

FIG. 4A shows exemplary steps in a process of manufacturing an optical film according to an embodiment of the invention;

FIG. 4B shows exemplary steps in a process of manufacturing an optical film according to another embodiment of the invention;

FIG. 5 shows a perspective view of an optical film according to a third embodiment of the invention;

FIG. 6 shows a perspective view of an optical film according to a fourth embodiment of the invention;

FIG. 7 shows a perspective view of an optical film according to a fifth embodiment of the invention;

FIG. 8 shows a perspective view of an optical film according to a sixth embodiment of the invention;

FIG. 9 shows a perspective view of an optical film according to a seventh embodiment of the invention;

FIG. 10 shows a perspective view of an optical film according to a eighth embodiment of the invention;

FIG. 11 shows a flowchart of a manufacturing method of the optical film according to an embodiment of the invention; and

FIG. 12 shows a cross-sectional view of a liquid crystal display device according to an embodiment of the invention.

### DETAILED DESCRIPTION OF EXEMPLARY EMBODIMENTS

Reference will now be made in detail to exemplary embodiments of the present invention, examples of which are illustrated in the accompanying drawings. Wherever possible, the same reference numbers will be used throughout the drawings to refer to the same or like parts.

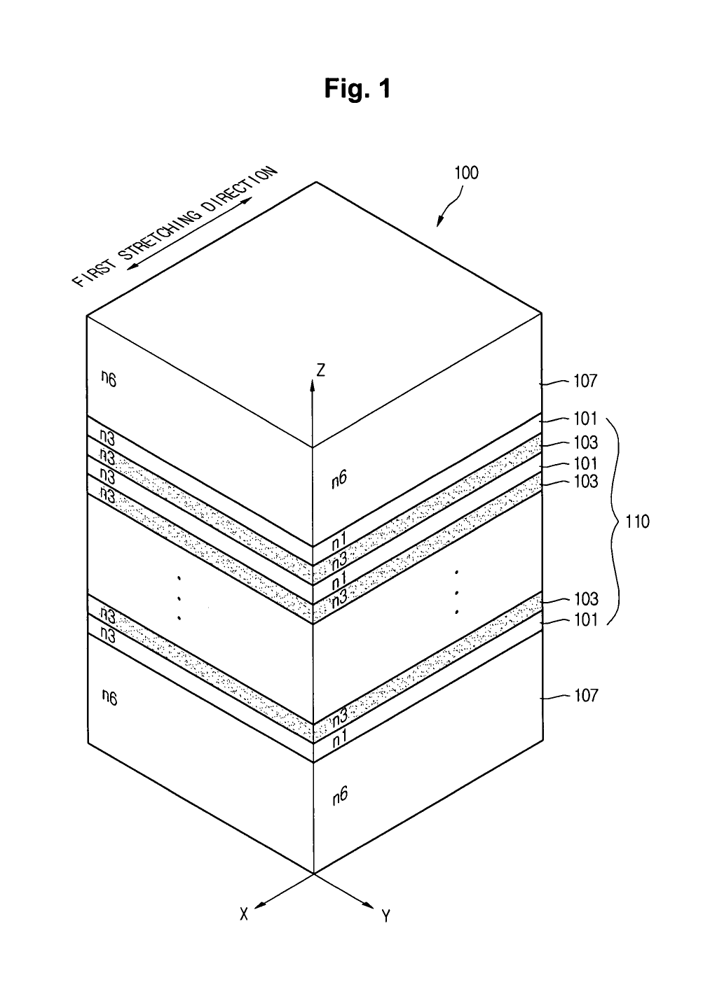

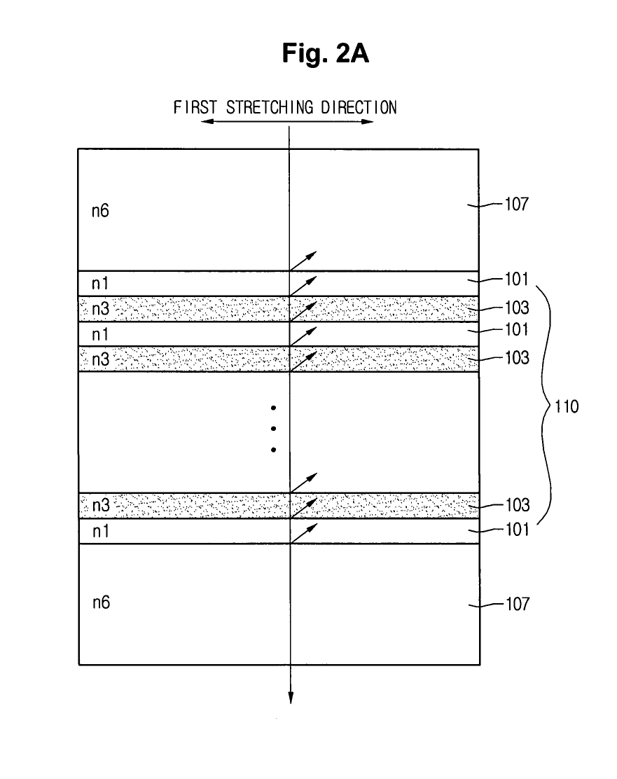

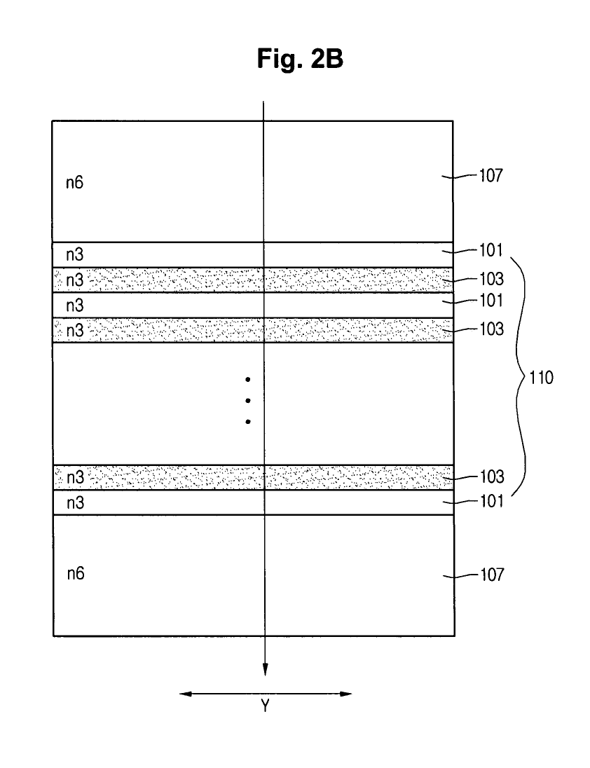

FIG. 1 shows a perspective view of an optical film according to a first embodiment of the invention, FIG. 2A shows a side view of the optical film of FIG. 1 in a stretching direction, and FIG. 2B shows a side view of the optical film of FIG. 1 in a non-stretching direction. Referring to FIG. 1, the optical film 100 includes a multi-layered sheet 110. The multi-layered sheet 110 includes a plurality of polymer layers 101 having a first refractive index n1 in a stretching direction on a plane, and having a third refractive index n3 in a non-stretching direction, and a plurality of copolymer layers 103 alternating with the polymer layers 101, and having the third refractive index n3 in the stretching direction and the non-stretching direction. In an embodiment, the non-stretching direction is perpendicular to the stretching direction on the plane of the optical film 100.

The optical film 100 further includes a protection sheet 107 directly contacting at least one side of the multi-layered sheet 110. Since the protection sheet 107 is formed on the upper and lower surfaces of the multi-layered sheet through co-extrusion, no separate adhesive member is required. After the protection sheet is formed on one side of the multi-layered sheet through the co-extrusion, the multi-layered sheet and the protection sheet are drawn in a planar stretching direction. In an embodiment, the non stretching direction is perpendicular to the stretching direction on the plane of the optical film 100.

The polymer layer 101 of the multi-layered sheet 110 is drawn in the stretching direction, and has the first refractive index n1 in the stretching direction. Further, the polymer layer 101 has the third refractive index n3 in the non-stretching direction. Herein, the first refractive index n1 is greater than the third refractive index n3.

Assuming that one axis on the plane of the multi-layered sheet 110 is an X-axis, a perpendicular axis on the plane including the X-axis is an Y-axis, an axis perpendicular to the plane is a Z-axis, the stretching direction is parallel to the X-axis, and the non-stretching direction is parallel to the Y-axis.

The optical film 100 transmits one component of incident light and reflects the other component of the light through a difference in the refractive index of the optical film 100. The thickness of the optical film 100 can be controlled to obtain maximum performance of the optical film 100. Also, it is possible to control the thicknesses of the polymer 101 and the copolymer 103 constituting the optical film 100, respectively.

In the optical film 100 in which the plurality of polymer layers 101 and the plurality of copolymer layers 103 are alternately arranged, each of the polymer layers 101 and the copolymer layers 103 may have a different thickness. For example, the thicknesses of the polymer layers 101 may gradually increase from the outer side to the center of the optical film 100. Likewise, the thicknesses of the copolymer layers 103 may gradually increase from the outer side to the center of the optical film 100. On the other hand, the thicknesses of the polymer layers 101 can gradually decrease from the outer side to the center of the optical film 100. Also, the thicknesses of the copolymer layers 103 can gradually decrease from the outer side to the center of the optical film 100.

Since the first refractive index n1 formed in the X-axis, the third refractive index n3 formed along the Y-axis, and a refractive index (not determined) formed along the Z-axis are different in the polymer layer 101, the polymer layer 101 may have a birefringence property.

The copolymer layer 103 has the third refractive index n3 along the X and Y-axes.

A refractive index formed along the X-axis and a refractive index formed along the Y-axis may be equal to each other in the protection sheet 107. The protection sheet 107 may include the copolymer layer 103 or the polymer layer 101. The protection sheet 107 has a sixth refractive index n6. There is almost no difference in a refractive index of the polymer layer 101 and the copolymer layer 103 in the non-stretching direction.

Therefore, the multi-layered sheet 110 in which the copolymer layers 103 and the polymer layers 101 are alternately arranged reflects most of a first light component of incident light, and transmits most of a second light component.

For example, a light source generates light having a p-wave component and an s-wave component, and the optical film 100 transmits the p-wave component of light to a liquid crystal display panel and reflects the s-wave component of the light. The s-wave component reflected from the optical film 100 is then incident onto a reflector disposed at the back of the optical film 100. The reflector subsequently changes the phrase of a portion of the reflected s-wave component of light into p-wave component. As a result, the reflected light then includes a first remaining portion of s-wave component and a converted portion of p-wave component, and the reflector reflects such light back to the optical film 100. Thus, the optical film 100 transmits the converted portion of p-wave component onto the liquid crystal display panel. Moreover, as the optical film 100 transmits the converted portion of p-wave component, the optical film 100 also reflects the first remaining portion of s-wave component back to the reflector. In particular, the first remaining portion of s-wave component is smaller than the previous reflected portion of light. Further, the first remaining portion of s-component component of light is again incident on the reflector and a portion of such light is converted into p-wave component to be transmitted through the optical film 100. Therefore, a portion of the reflected s-wave component of light is recycled and transmitted through the optical film 100 as a p-wave component of light, thereby improving optical efficiency.

The s-wave component and p-wave component of light can be perpendicular to each other and vibrate with respect to a traveling direction of light. For example, light can be incident onto the optical film 100 in the Z-axis direction, and the s-wave component and p-wave component can vibrate in X-axis and Y-axis directions. Preferably, the vibration direction of the s-wave component is parallel with the first stretching direction of the multi-layer sheet 110, and the vibration direction of the p-wave component is parallel with the second stretching direction of the multi-layer sheet 110.

According to an embodiment of the invention, a first light component of the light incident onto the multi-layered sheet 110 is reflected, and a second light component passes through the multi-layered sheet 110.

Since there is a large difference in the refractive indexes of the polymer layer 101 and the copolymer layer 103 constituting the multi-layered sheet 110 in the stretching direction, an incident first light component is reflected by a boundary between the polymer layer 101 and the copolymer layer 103. On the other hand, since there is almost no difference between the refractive indexes of the polymer layer 101 and the copolymer layer 103 constituting the multi-layered sheet 110 in the non-stretching direction, an incident second light component can directly pass through the polymer layer 101 and the copolymer layer 103.

In an embodiment, the vibration direction of the first light component coincides with the stretching direction, and the vibration direction of the second light component coincides with the non stretching direction. The reflected first light component is reflected again by a reflector disposed on the rear side of the optical film, and the reflected light is re-incident onto the optical film 100. The first light incident onto the reflector has a first light component and a second light component while it is reflected.

The second light component of the light re-incident onto the optical film 100 passes through the multi-layered sheet 110, and the first light component of the light is reflected again. The reflected first light component is reflected by the reflector is reflected by the reflector and re-incident onto the optical film 100. A second light component of the re-incident light passes through the multi-layered sheet 110, and a first light component of the re-incident light is reflected again.

As described above, the optical film 100 selectively reflects and transmits incident thereon, and selectively transmits only a first light component of light that is reflected and re-incident to increase light brightness on the whole.

The protection sheet 107 can be a copolymer layer or a polymer layer. A material constituting the protection sheet 107 can include a polyester-based material. In an embodiment, the polyester-based material includes at least one selected from the group consisting of polyethylene terephthalate, polytrimethylene terephthalate, polyethylene naphthalate, polyethylene terephthalate copolymer, polytrimethylene terephthalate copolymer, and polyethylene naphthalate copolymer. The protection sheet 107 includes at least one of the polymer layer 101 and the copolymer layer 103.

For example, in the case where the protection sheet 107 is formed of the copolymer constituting the multi-layered sheet 110, affinity between the protection sheet 107 and the multi-layered sheet 110 increases. Therefore, wrinkle generation on the film and exfoliation of the protection sheet 107 from the multi-layered sheet 110 can be prevented.

Also, since there is no adhesive member between the protection sheet 107 and the multi-layered sheet 110, a light loss due to the adhesive member can be reduced and brightness can be improved even more.

Also, when the polymer layer 101 and the copolymer layer 103 are extrusion-molded to manufacture the multi-layered sheet 110, molten polymer materials are formed as the protection sheet 107 on one side of the multi-layered sheet 110. Therefore, foreign substances are not attached between the multi-layered sheet 110 and the protection sheet 107 compared to a process of attaching a separately manufactured protection sheet to the multi-layered sheet using an adhesive member.

Also, since the polymer layer 101 and the copolymer layer 103 are extrusion-molded to manufacture the multi-layered sheet 110, and the protection sheet 107 is extrusion-molded and formed on the one side of the multi-layered sheet 110, and then the multi-layered sheet 110 and the protection sheet 107 are drawn together, surface scratches of the multi-layered sheet 110 that may be generated during the drawing process can be prevented. Also, thermal damage such as surface crystallization of the surface portion of the multi-layered sheet 110 that may be generated during a subsequent heat treatment process can be effectively reduced.

The protection sheet 107 can have a thickness in the range of about 25 to about 200 μm. Also, the protection sheet 107 can have the same thickness as the multi-layered sheet 110.

A refraction characteristic of the polymer layer 101 of the optical film 100 changes in one axis direction due to drawing. The term ‘drawing’ denotes a series of processes of applying physical force to the polymer layer 101 having a film shape through extrusion-molding, and drawing the polymer layer 101 in one direction. The refractive index of the polymer layer 101 changes depending on a direction in which the drawing process is performed, so that the polymer layer 101 has birefringence. The refractive index of the polymer layer 101 may change depending on a draw ratio. Generally, as a draw ratio increases, a refractive index increases.

A refraction index of the copolymer 103 is not changed by a draw process.

Meanwhile, an incident plane of the multi-layered sheet 110 onto which the light is incident may be formed of the copolymer layer 103 or the polymer layer 101. An emission plane of the multi-layered sheet 110 from which the light that has passed through the multi-layered sheet 110 is emitted may be formed of the copolymer layer 103 or the polymer layer 101.

The polymer layer 101 includes polyethylene terephthalate (PET). The copolymer 103 includes PET and at least one selected from the group consisting of PTT, PEN, PET copolymer, PTT copolymer, and PEN copolymer. In an embodiment, the copolymer layer 103 may be formed by mixing and polymerizing more than 50 w %, e.g., about 80 w % of PET, and less than 50 w %, e.g., about 20 w % of an additional member. The additional member may be formed of PEN. In the case where the polymer layers 101 of the optical film 100 are formed of PET, it is preferable that the copolymer layers 103 alternately arranged with the polymer layers 101 be formed of a PET copolymer. The polymer layer 101 and the copolymer layer 103 constituting the optical film 100 may be formed of at least one layer or of several tens to several thousands of layers which are alternately arranged.

A difference between the first refractive index n1 of the polymer layer 101 and the third refractive index n3 of the copolymer layer 103 may be 0.01 or more. For example, a difference between the first refractive index n1 of the polymer layer 101 and the third refractive index n3 of the copolymer layer 103 may be 0.05 or more. Alternatively, a difference between the first refractive index n1 of the polymer layer 101 and the third refractive index n3 of the copolymer layer 103 may be 0.1 or more. For example, a difference between the first refractive index n1 of the polymer layer 101 and the third refractive index n3 of the copolymer layer 103 may be 0.2-0.5.

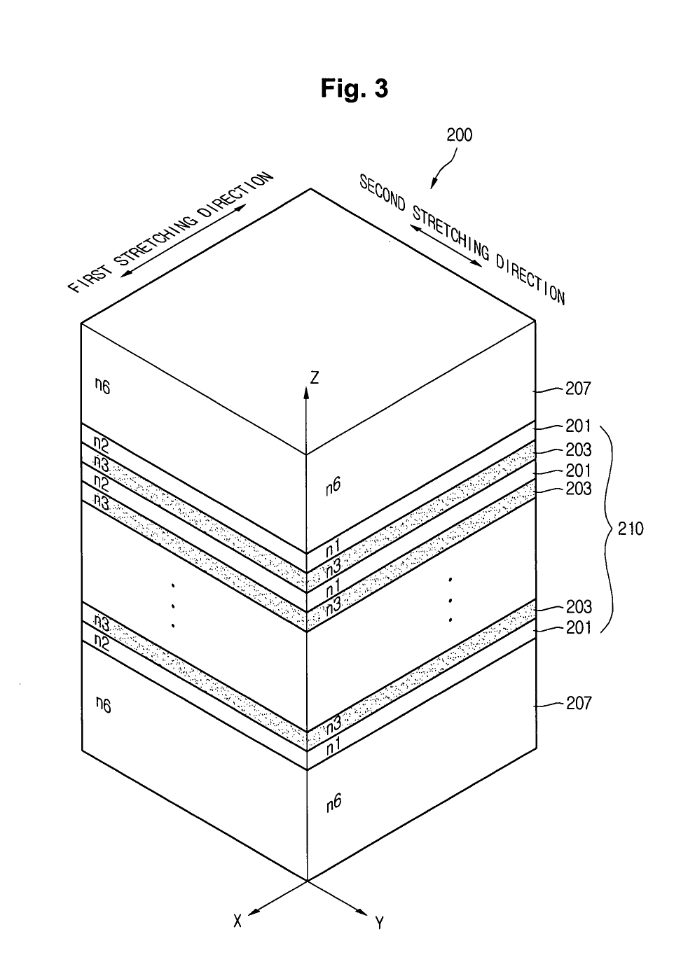

FIG. 3 shows a perspective view of an optical film according to a second embodiment of the invention. Though the materials, shapes, and numerical values associated with the multi-layered sheet and the protection sheet shown in FIG. 3 are not described in detail, these characteristics are substantially the same as those described in relation to FIG. 1.

Referring to FIG. 3, the optical film 200 includes the multi-layered sheet 210. The multi-layered sheet 210 includes a plurality of polymer layers 201 having a first refractive index n1 along a first stretching direction on a plane, and having a second refractive index n2 along a second stretching direction, and a plurality of copolymer layers 203 disposed alternately with the polymer layers 201, and having a third refractive index n3 in the first and second stretching directions. The first and second stretching directions can be perpendicular to each other on one plane, or they can have other directions.

The optical film 200 further includes a protection sheet 207 formed on at least one side of the multi-layered sheet 210. Like the multi-layered sheet 210, the protection sheet 207 is formed through extrusion molding to directly contact one side of the multi-layered sheet 210. Hence, there is no adhesive member between the protection sheet and the multi-layered sheet. Accordingly, a light loss due to the adhesive member can be reduced, and thus brightness can be improved even more.

The protection sheet 207 can be formed of a copolymer layer or a polymer layer, and has a sixth refractive index. The protection sheet 207 can be formed of the copolymer layer or the polymer layer included in the multi-layered sheet. When the protection sheet 207 is formed of the copolymer constituting the multi-layered sheet 210, affinity between the protection sheet 207 and the multi-layered sheet 210 increases. Thus, wrinkle generation on the film and exfoliation of the protection sheet 207 from the multi-layered sheet 210 can be prevented.

The material of the protection sheet 207 can include a polyester-based material. The polyester-based material includes at least one selected from the group consisting of polyethylene terephthalate, polytrimethylene terephthalate, polyethylene naphthalate, polyethylene terephthalate copolymer, polytrimethylene terephthalate copolymer, and polyethylene naphthalate copolymer.

The protection sheet 207 can have a thickness of about 25 to about 200 μm. Also, the protection sheet 207 can have substantially the same thickness as the multi-layered sheet 210.

Meanwhile, a difference between the first refractive index n1 and the third refractive index n3 is greater than a difference between the second refractive index n2 and the third refractive index n3 in the multi-layered sheet 210. The first refractive index n1 is greater than the third refractive index n3, the second refractive index n2 is greater than the third refractive index n3, and the first refractive index is greater than the second refractive index n2.

Meanwhile, a refractive index of the polymer layer 201 of the optical film 200 changes along one axis direction by a draw process. The polymer layer 201 has birefringence that its refractive index changes along a stretching direction. The refractive index of the polymer layer 201 can change depending on a draw ratio. Generally, as a draw ratio increases, a refractive index increases.

For example, the multi-layered sheet 210 is drawn so that a draw ratio along the first stretching direction becomes n (n>0) and a draw ratio along the second stretching direction becomes m (m>0). The refractive index of the multi-layered sheet 210 changes depending on the draw ratio. 10069 When the draw ratio n along the first stretching direction is greater than the draw ratio along the second stretching direction m, the polymer layer 201 has the first refractive index n1 along the first stretching direction on the plane, and has the second refractive index n2 along the second stretching direction. At this point, the copolymer layers 203 alternately arranged with the polymer layers 201 have the third refractive index n3 in the first and second stretching directions.

Assuming that one axis on the plane of the multi-layered sheet 210 is an X-axis, a perpendicular axis on the plane including the X-axis is an Y-axis, an axis perpendicular to the plane is a Z-axis, the first stretching direction is parallel to the X-axis, and the second stretching direction is parallel to the Y-axis.

Since the polymer layer 201 has the first refractive index n1 along the X-axis, the second refractive index n2 along the Y-axis, and the third refractive index n3 (not determined) along the Z-axis, the polymer layer 201 can be a birefringence layer having birefringence. The refractive index of the protection sheet 207 along the X axis can the same as the refractive index of the protection sheet 207 along the Y axis.

Meanwhile, the multi-layered sheet 210 in which the copolymer layers 203 and the polymer layers 201 are alternately arranged has a characteristic of reflecting most of the first light component and transmitting most of the second light component.

For example, the optical film 200 transmits P-waves of the components of light generated from a lamp to an LC display panel, and reflects S-waves to a light guide plate.

Also, the S-waves reflected by the optical film 200 are reflected by a reflector disposed on the rear side of the optical film 200 to the optical film 200. During this process, the S-waves are converted into P-waves and pass through the optical film 200 again, so that light efficiency is improved on the whole.

For example, in the case where the protection sheet 207 is formed of the copolymer constituting the multi-layered sheet 210, affinity between the protection sheet 207 and the multi-layered sheet 210 increases. Therefore, a problem such as wrinkle generation on the film and exfoliation of the protection sheet 207 from the multi-layered sheet 210 can be solved.

Also, since there is no adhesive member between the protection sheet 207 and the multi-layered sheet 210, a light loss due to the adhesive member can be reduced and brightness can be improved even more.

Also, when the polymer layer 201 and the copolymer layer 203 are extrusion-molded to manufacture the multi-layered sheet 210, molten polymer materials are formed as the protection sheet 207 on one side of the multi-layered sheet 210. Therefore, foreign substances are not attached between the multi-layered sheet 210 and the protection sheet 207 compared to a process of attaching a separately manufactured protection sheet to the multi-layered sheet 210 using an adhesive member.

Also, since the polymer layer 201 and the copolymer layer 203 are extrusion-molded to manufacture the multi-layered sheet 210, and the protection sheet 207 is extrusion-molded and formed on the one side of the multi-layered sheet 210, and then the multi-layered sheet 210 and the protection sheet 207 are drawn together, surface scratches of the multi-layered sheet 210 that may be generated during the drawing process can be prevented. Also, thermal damage such as surface crystallization of the surface portion of the multi-layered sheet 210 that may be generated during a subsequent heat treatment process can be effectively reduced.

A difference between the first refractive index n1 of the polymer layer 201 and the third refractive index n3 of the copolymer layer 203 can be 0.01 or more. For example, a difference between the first refractive index n1 of the polymer layer 201 and the third refractive index n3 of the copolymer layer 203 can be 0.05 or more. Alternatively, a difference between the first refractive index n1 of the polymer layer 201 and the third refractive index n3 of the copolymer layer 203 can be 0.1 or more. For example, a difference between the first refractive index n1 of the polymer layer 201 and the third refractive index n3 of the copolymer layer 203 can be 0.2-0.5.

The multi-layered sheet 210 in which the polymer layers 201 and the copolymer layers 203 are alternately arranged can be uniaxial-drawn in the first stretching direction.

A difference between the second refractive index n2 and the third refractive index n3 of the copolymer layers 203 can be 0.1 or less. A difference between the second refractive index n2 and the third refractive index n3 of the copolymer layers 203 can be 0.05 or less. A difference between the second refractive index n2 and the third refractive index n3 of the copolymer layers 203 can be 0.01-0.

The multi-layered sheet 210 in which the polymer layers 201 and the copolymer layers 203 are alternately arranged can be uniaxial-stretched in the first stretching direction. Also, the multi-layered sheet 210 in which the polymer layers 201 and the copolymer layers 203 are alternately arranged can be biaxial-stretched by being drawn in the first stretching direction and then drawn in the second stretching direction.

In the case where the multi-layered sheet 210 is stretched at least one time in different directions, a successive thermal fixing process is performed. Therefore, defects such as wrinkling and bending are not generated even when the multi-layered sheet 210 shrunk in the width or length direction residual internal stress of the multi-layered sheet 210, and a mechanical characteristic of the optical film 200 is reinforced.

Also, the protection sheet 207 formed of a polymer or a copolymer is formed on the upper and lower surfaces of the multi-layered sheet 210 to increase affinity between the protection sheet 207 and the multi-layered sheet 210, and to prevent exfoliation of the protection sheet 207 from the multi-layered sheet 210.

Here, though description has been made using a biaxial stretch of a first stretch and a second stretch for example, a draw process can be performed two or more times in order to improve the characteristic of the optical film according to the present invention. Though the stretching directions can be perpendicular to each other, they can also cross each other in any other angle.

Since the multi-layered sheet 210 is stretched using physical force, it can shrink in a direction opposite to the stretching direction by residual internal stress before a thermal fixing process.

This shrinkage of the optical film 200 changes the characteristic of the film to reduce an optical characteristic or cause unexpected phenomenon. According to the present invention, it is possible to manufacture a wrinkle-free or bending-free optical film having excellent thermal durability and excellent mechanical strength even when the optical film is shrunk by biaxial stretch or multi-axial stretch.

For example, the multi-layered sheet 210 is drawn in the first stretching direction, which is a primary stretching direction, and then drawn in the second stretching direction. The shrinkage direction may be a direction opposite to the first stretching direction or the second stretching direction. The shrinkage rate of the optical film 200 can be the same as one of the draw ratio n and the draw ratio m, or smaller. That is, the polymer layer 201 and the copolymer layer 203 of the optical film 200 can be shrunk as much as the draw amount or shrunk less than the draw amount.

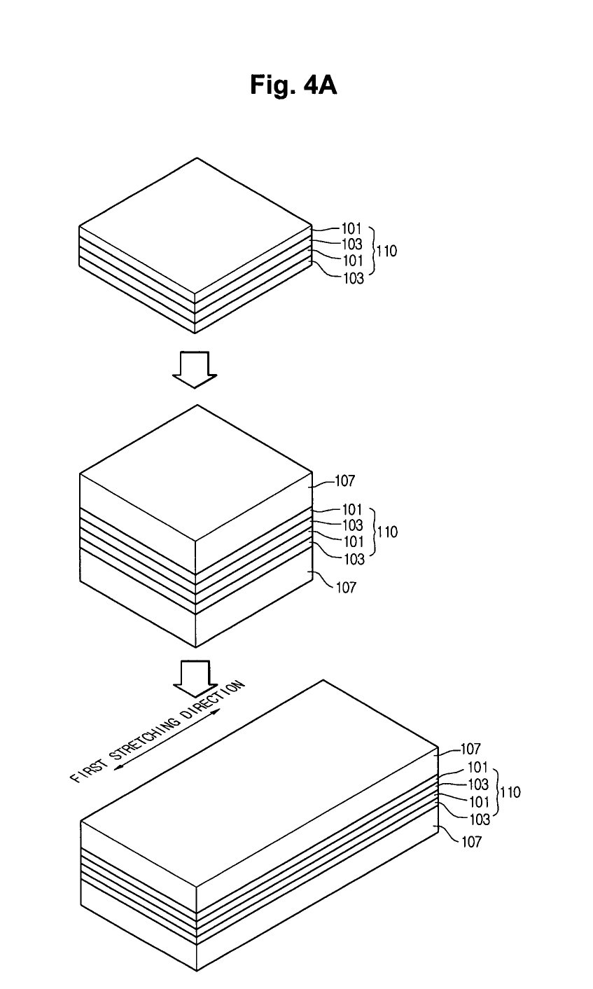

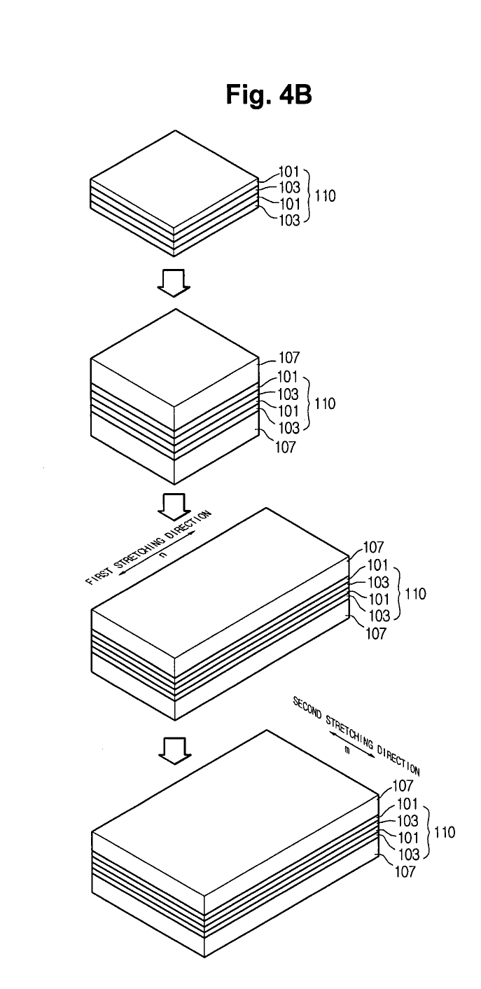

FIG. 4A shows exemplary steps in a process of manufacturing an optical film according to an embodiment of the invention. FIG. 4B shows exemplary steps in a process of manufacturing an optical film according to another embodiment of the invention. Referring to FIG. 4A, molten polymer material and molten copolymer material are extrusion-molded, respectively, to form the copolymer layer 103 in which the plurality of polymer layers 101 and copolymer layers 101 are alternately stacked. The stacked polymer layers 101 and the copolymer layers 103 are feedback to overlap at least one time and form the multi-layered sheet 110.

The polymer layer 101 has the same initial refractive index n0 with respect to an X-Y plane, and the copolymer layer 103 has the same refractive index n3 with respect to the X-Y plane. The refractive index of the polymer layer 101 may be substantially the same as that of the copolymer layer 103.

Then, the molten polymer material is extrusion-molded to at least one side of the multi-layered sheet to form the protection sheet directly contacting the multi-layered sheet. Since the protection sheet can be formed on the multi-layered sheet through co-extrusion without a separate adhesive member, the optical film 100 can be made thin. Accordingly, not only light efficiency improves but also manufacturing process is simplified and defect generation caused due to foreign substances is small because the protection sheet is formed integrally with the optical film 100.

After that, the multi-layered sheet 110 and the protection sheet are uniaxial-stretched in the first stretching direction. Each of the multi-layered sheet 110 and the protection sheet has a draw ratio of n (n>0) along the first stretching direction. The length of the multi-layered sheet 110 is stretched in the stretching direction three times to eight times more than the original length.

According to an embodiment of the present invention, an optical film can be manufactured by forming the multi-layered sheet through co-extrusion, forming a protection sheet on at least one side of the multi-layered sheet through co-extrusion, and coaxial-stretching them.

Also, according to an embodiment of the present invention, the multi-layered sheet is formed by co-extrusion, the protection sheet is formed on at least one side of the multi-layered sheet through co-extrusion, and a biaxial stretching of stretching them in the first stretching direction, and stretching them in the second stretching direction is performed, so that the optical film can be manufactured.

Referring to FIG. 4B, after the multi-layered sheet 110 and the protection sheet are manufactured in the order described in FIG. 4A, the multi-layered sheet 110 and the protection sheet are stretched together in the second stretching direction on the plane.

A draw ratio along the second stretching direction is m (n>m), and the lengths of the multi-layered sheet 110 and the protection sheet are further stretched in the second stretching direction by 0.1 time to 1.5 times more than the original length.

After that, a process of thermally fixing the multi-layered sheet 110 is performed to complete the optical film 100. Though the first stretching direction and the second stretching direction may be perpendicular to each other, they fall within the scope of the present invention as far as they are directions different from each other.

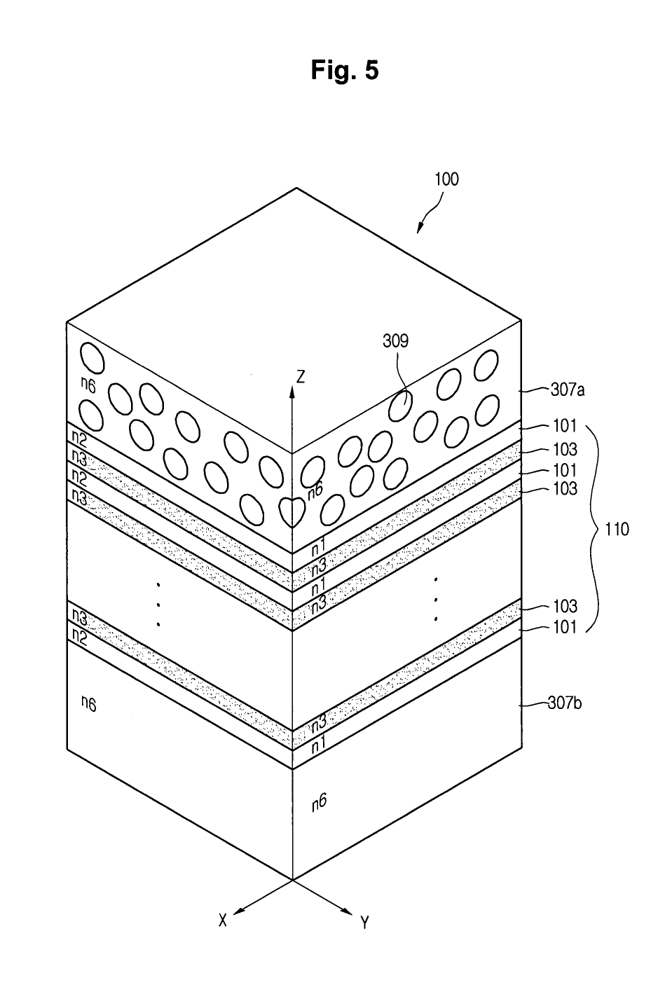

FIG. 5 shows a perspective view of an optical film according to a third embodiment of the invention. Here, since the optical film of FIG. 5 is substantially similar to the optical film of FIG. 1, detailed description of the same or like parts will be omitted. Though the materials, shapes, and the relative position of the multi-layered sheet and the protection sheet shown in FIG. 5 are not described in detail, these characteristics are substantially the same as those described in reference to FIG. 1.

The optical film 100 includes a first protection sheet 307a and a second protection sheet 307b formed on the upper and lower surfaces of the multi-layered sheet 110, respectively. Each of the first and second protection sheets 307a and 307b can be formed of a copolymer layer and a polymer layer. The first protection sheet 307a serves as an incident plane of light, and can include inorganic particles 309. The inorganic particles 309 include at least one selected from the group consisting of silica, TiO₂, and CaCO₃. The optical film 100 including the protection sheet containing the inorganic particles 309 diffuses light incident onto the optical film 100 to prevent partial concentration of light and allow light to be uniformly illuminated onto the LC display panel.

The optical film having the above-described structure can be manufactured as described below. First, a molten polymer material and a molten copolymer material are extrusion-molded to form the plurality of polymer layers 101 and copolymer layers 103 alternately stacked with the polymer layers 101. The stacked polymer layers 101 and copolymer layers 103 are feedback to overlap at least one time and form the multi-layered sheet 110. The polymer layer 101 has the same refractive index n3 with respect to the X-Y plane, and the copolymer layer 103 has the same refractive index n3 with respect to the X-Y plane.

Then, the multi-layered sheet 110 is stretched in the first stretching direction, so that the polymer layer 101 has the first refractive index n1 along the first stretching direction, and the copolymer layer 103 has the second refractive index n2 along the first stretching direction.

At this point, the first stretching direction is parallel to the X-axis, and the thicknesses of the polymer layer 101 and the copolymer layer 103 constituting the multi-layered sheet 110 are reduced by the stretching. The length of the multi-layered sheet 110 is stretched three times to eight times in the first stretching direction.

Next, as a selective operation, the multi-layered sheet 110 are stretched by 0.1-1.5 times in the second stretching direction on the plane to allow the polymer layer 101 to have the second refractive index n2 along the second stretching direction, and allow the copolymer layer 103 to have the second refractive index n2 along the second stretching direction.

In an embodiment, the first stretching direction and the second stretching direction may be perpendicular to each other. In another embodiment, the first stretching direction may cross the second stretching direction in accordance with a different orientation.

After that, a process of thermally fixing the multi-layered sheet 110 is performed. Finally, the first and second protection sheets 307a and 307b are disposed on the upper and lower surfaces of the multi-layered sheet 110. Various methods can be used for forming the protection sheets 307a and 307b on one side of the multi-layered sheet 110.

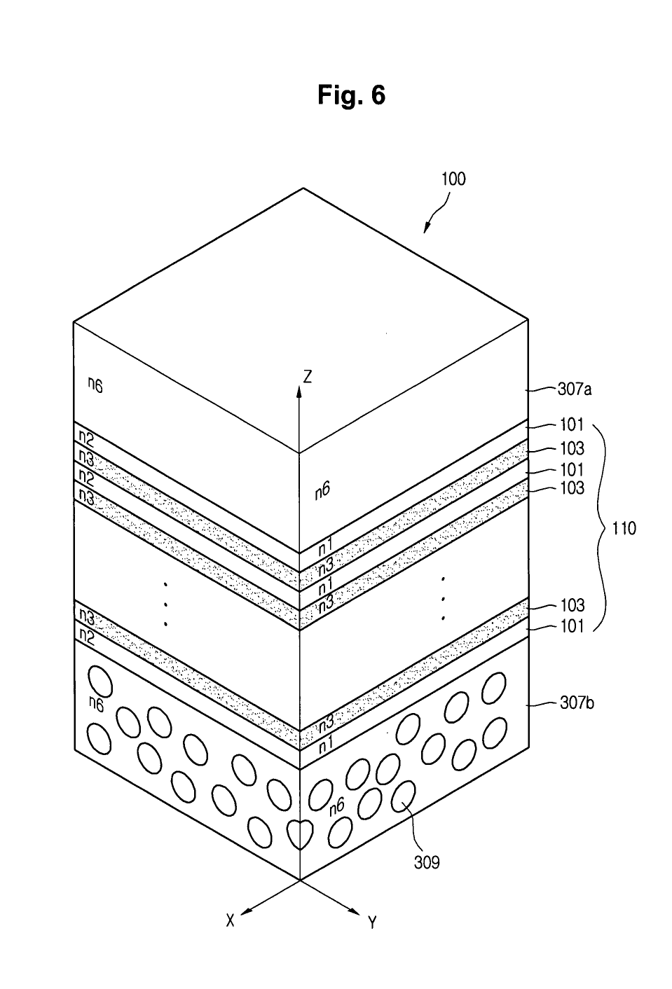

FIG. 6 shows a perspective view of an optical film according to a fourth embodiment of the invention. Here, since the optical film of FIG. 6 is similar to the optical film of FIG. 5, detailed description of the same or like parts will be omitted. 10107 Referring to FIG. 6, the optical film 100 includes a first protection sheet 307a and a second protection sheet 307b formed on the upper and lower surfaces of a multi-layered sheet 110, respectively. Also, each of the first and second protection sheets 307a and 307b can be formed of a copolymer layer and a polymer layer. The second protection sheet 307b functions as an emission plane of light, and can include inorganic particles 309.

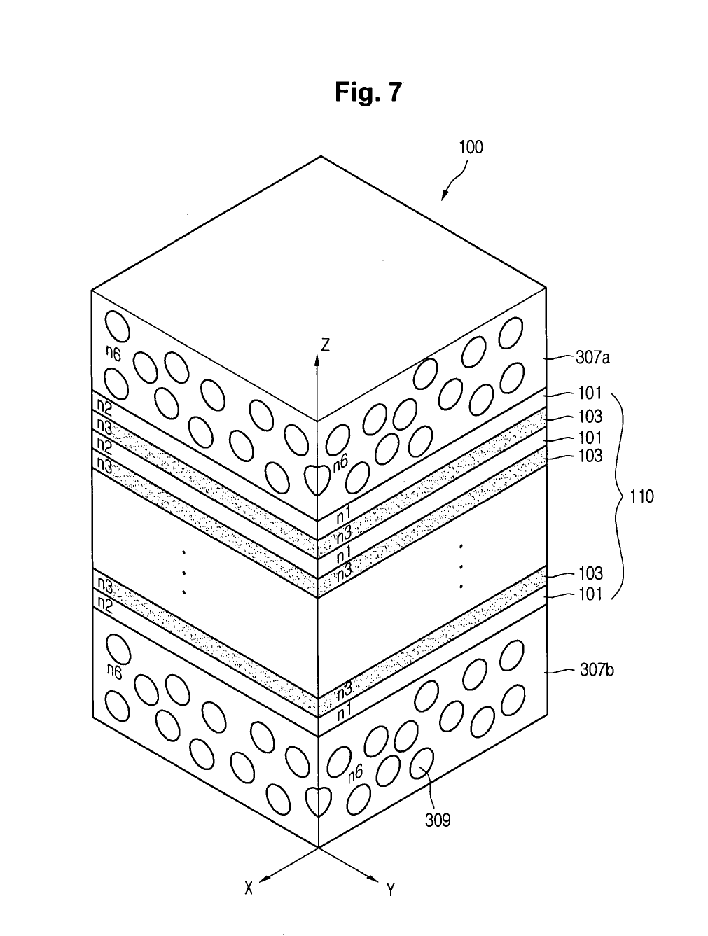

FIG. 7 shows a perspective view of an optical film according to a fifth embodiment of the invention. Here, since the optical film of FIG. 7 is similar to the optical film of FIG. 5, detailed description of the same or like parts will be omitted. Referring to FIG. 7, the optical film 100 includes a first protection sheet 307a and a second protection sheet 307b formed on the upper and lower surfaces of a multi-layered sheet 110, respectively. Each of the first and second protection sheets 307a and 307b can be formed of a copolymer layer and a polymer layer.

The first protection sheet 307a functions as an incident plane of light, and the second protection sheet 307b functions as an emission plane of light. Each of the first and second protection sheets 307a and 307b can include inorganic particles 309.

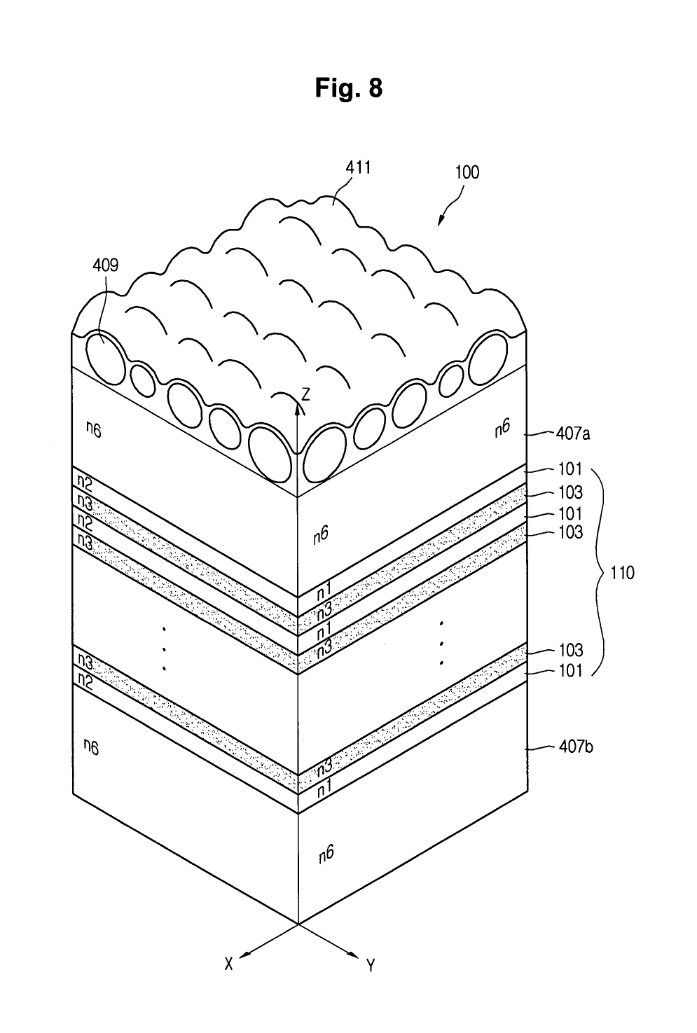

FIG. 8 shows a perspective view of an optical film according to a sixth embodiment of the invention. Here, since the optical film of FIG. 8 is similar to the optical film of FIG. 1, detailed description of the same or like parts will be omitted. Though the materials, shapes, and the relative positions of the multi-layered sheet and the protection sheet shown in FIG. 8 are not described in detail, these characteristics are substantially the same as those described in reference to FIG. 1.

The optical film 100 includes a first protection sheet 407a and a second protection sheet 407b formed on the upper and lower surfaces of a multi-layered sheet 110, respectively. Each of the first and second protection sheets 407a and 407b can be formed of a copolymer layer and a polymer layer. The first protection sheet 407a functions as an incident plane of light, and can further include a diffusion member 411 on the first protection sheet 407a.

The diffusion member 411 is a transparent polymer layer including inorganic particles 409. The inorganic particles 409 include at least one selected from the group consisting of silica, TiO₂, and CaCO₃. The optical film 100 including the diffusion member 411 diffuses light incident onto the optical film 100 to prevent partial concentration of light and allow light to be uniformly illuminated onto an LC display panel.

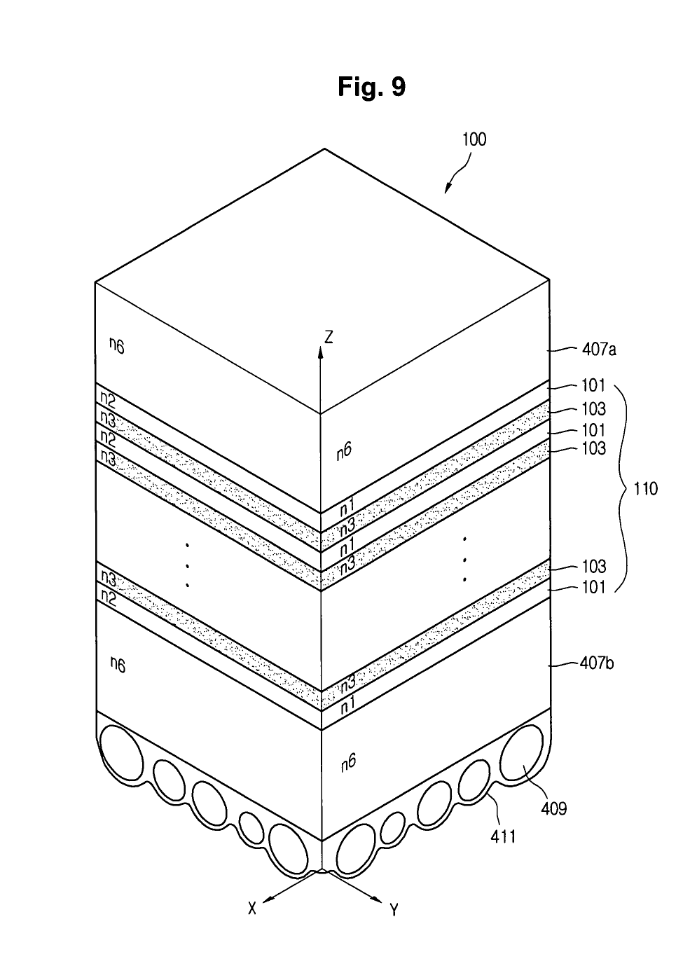

FIG. 9 shows a perspective view of an optical film according to a seventh embodiment of the invention. Here, since the optical film of FIG. 9 is similar to the optical film of FIG. 8, detailed description of the same or like parts will be omitted. The optical film 100 includes a first protection sheet 407a and a second protection sheet 407b formed on the upper and lower surfaces of a multi-layered sheet 110, respectively. Each of the first and second protection sheets 407a and 407b can be formed of a copolymer layer and a polymer layer. The second protection sheet 407b serves as an emission plane of light, and can further include a diffusion member 411 on the second protection sheet 407b.

The diffusion member 411 is a transparent polymer layer including inorganic particles 409. The inorganic particles 409 include at least one selected from the group consisting of silica, TiO₂, and CaCO₃.

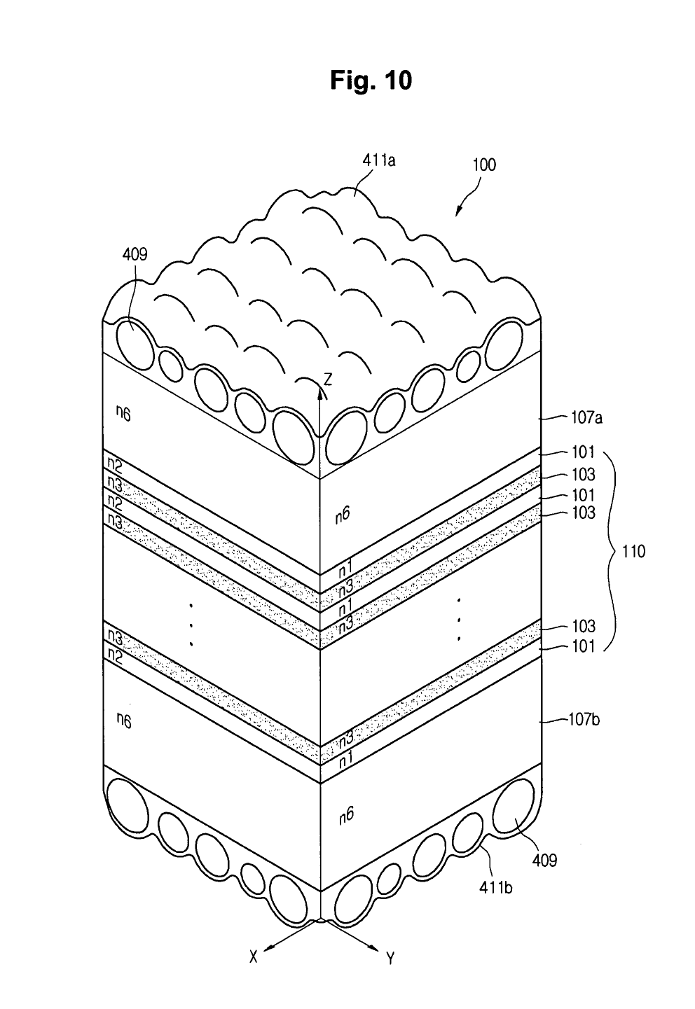

FIG. 10 shows a perspective view of an optical film according to an eighth embodiment of the invention. Here, since the optical film of FIG. 10 is similar to the optical film of FIG. 9, detailed description of the same or like parts will be omitted. Though the materials, shapes, and the relative positions of the multi-layered sheet and the protection sheet shown in FIG. 8 are not described in detail, these characteristics are substantially the same as those described in reference to FIG. 1.

The optical film 100 includes a first protection sheet 407a and a second protection sheet 407b formed on the upper and lower surfaces of a multi-layered sheet 110, respectively. Each of the first and second protection sheets 407a and 407b can be formed of a copolymer layer 103 and a polymer layer 101. The first protection sheet 407a functions as an incident plane of light, and the second protection sheet 407b serves as an emission plane of light. Diffusion members 411 are further formed on the first and second protection sheets 407a and 407b, respectively.

The diffusion member 411 is a transparent polymer layer including inorganic particles 409. The inorganic particles 409 include at least one selected from the group consisting of silica, TiO₂, and CaCO₃. The optical film 100 including the diffusion member 411 diffuses light incident onto the optical film 100 to prevent partial concentration of light and allow light to be uniformly illuminated onto an LC display panel.

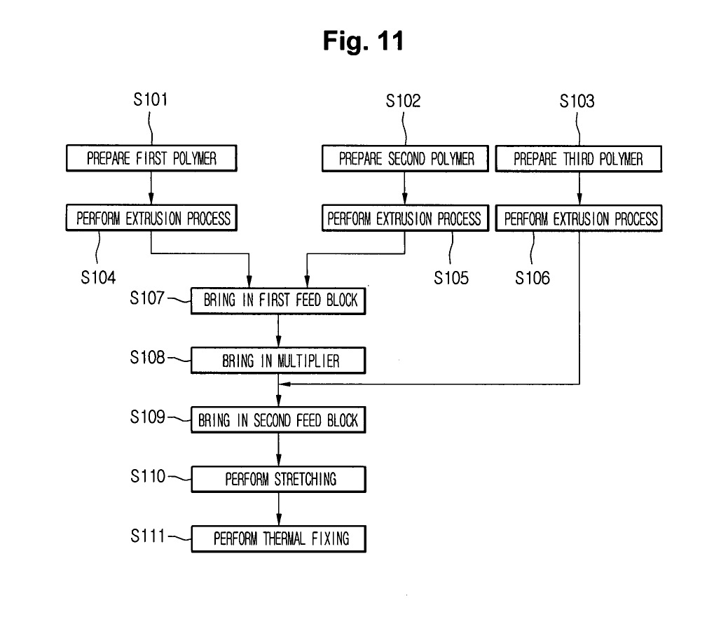

FIG. 11 shows a flowchart of a method for manufacturing an optical film according to an embodiment of the invention. In FIG. 11, at steps S 101 and S 102, a first polymer and a second polymer are prepared. For example, the first polymer can be PET. The second polymer can be co-PET, for example, manufactured by co-polymerizing the first polymer. The second polymer can be formed by mixing and polymerizing more than 50 w %, e.g., about 80 w % of PET, and less than 50 w %, e.g., about 20 w % of an additional material. The additional material can be PEN.

Meanwhile, at step S103, a third polymer is prepared. The third polymer can be formed of the same material as a material of one of the first and second polymers. The third polymer can be PET or co-polymerized PET. The third polymer may include at least one selected from the group consisting of polyethylene terephthalate, polytrimethylene, polyethylene naphthalate, polyethylene terephthalate copolymer, polytrimethylene terephthalate copolymer, and polyethylene naphthalate copolymer. Also, the third polymer may include inorganic particles.

Then, at step S104, the first polymer is carried into a first extruder and melted. The molten first polymer is extrusion-processed in a film shape and carried from the extruder. Concurrently, at step S105, the second polymer is carried into a first extruder and melted. The molten second polymer is extrusion-processed in a layer shape and carried from the extruder.

At step S107, the extrusion-processed first polymer layers and the extrusion-processed second polymer layers are carried into a first feed block and the first polymer layers and the second polymer layers are alternately stacked. The first feed block is an equipment used for making a film having a multi-layered structure. The first and second polymer layers are alternately stacked without being mixed.

For example, preliminary multi-layered sheets in which the first polymer layers and the second polymer layers are alternately stacked can have a 220-layered structure. At step S108, the preliminary multi-layered sheets carried from the first feed block are carried to a multiplier. The preliminary multi-layered sheets carried to the multiplier are mutually stacked. Accordingly, the number of layers of the preliminary multi-layered sheet reaches several times the original number of layers.

For example, a preliminary multi-layered sheet having a 220-layered structure in which the first polymer layers and the second polymer layers are alternately stacked in stacked in a four-layered structure again to form a multi-layered sheet having a 880-layered structure.

At step S109, the multi-layer sheet is carried into a second feed block. Concurrently, the prepared third polymer is carried into a third extruder and melted and the molten third polymer is extrusion-processed in a film shape at step S 106, and then carried from the extruder to the second feed block at step S109. The second feed block provides the third polymer layer on at least one side of the multi-layered sheet to form a preliminary optical film. The third polymer layer protects the multi-layered sheet from external foreign substances and impulse.

Next, at step S110, the preliminary optical film carried from the multiplier is stretched. A draw process of the preliminary optical film can be performed in a uniaxial direction or a multi-axial direction. The draw process of the preliminary optical film can be performed one time or several times. For example, a first draw process and a second draw process can be performed on the preliminary optical film. Before the draw process, the preliminary optical film has the same refractive index in an X axis and a Y axis on the plane of the first polymer layer. Also, the preliminary optical film has the same refractive index in an X axis and a Y axis on the plane of the second polymer layer. Also, the refractive index of the first polymer layer may be substantially identical to the refractive index of the second polymer layer.

The first draw process is to stretch the preliminary optical film in a first stretching direction. The first stretching direction can be the same direction as a movement direction of the preliminary optical film. Unlike this, the first stretching direction can be a direction different from a movement direction of the preliminary optical film. The refractive index of the stretched first polymer layer changes along the first stretching direction so that the first polymer layer has a first refractive index n1. The stretched second polymer layer has a refractive index that does not change even when the second polymer layer is stretched along the first stretching direction.

Next, the first stretched preliminary optical film is secondly stretched. The second draw process is to stretch the first stretched preliminary optical film in a second stretching direction different from the first stretching direction. The second stretching direction can be a direction perpendicular to the first stretching direction. The preliminary optical film is stretched in the second stretching direction on the plane, so that the first polymer layer has a second refractive index n2 along the second stretching direction, and the second polymer layer has a third refractive index n3 along the second stretching direction. Meanwhile, the preliminary optical film may be stretched several times in a predetermined direction as well as the first and second stretching directions.

The mechanical characteristic of the preliminary optical film is reinforced while the first and second draw processes are performed. Also, the preliminary optical film according to an embodiment of the present invention has an advantage that its optical characteristic change little even when the film is contracted or expanded due to an external environmental factor.

There can be various combinations in directions of the first and second draw processes. Also, there can be various combinations in draw ratios of the preliminary optical film during the first and second draw processes.

For example, the preliminary optical film has a draw ratio of n (n>0) along the first stretching direction. The length of the preliminary optical film is stretched in the stretching direction three times to eight times more than the original length. Also, a draw ratio along the second stretching direction is m (n>m), and the lengths of the preliminary optical film are further stretched in the second stretching direction by 0.1-1.5 times more than the original length.

For another example, the preliminary optical film can be stretched in the first stretch direction by 0.1-1.5 times more than the original length, and stretched in second stretch direction by 3-8 times more than the original length. That is, the preliminary optical film has a draw ratio p (p>0) in the first stretching direction, and a draw ratio q (q>p) in the second stretching direction. A difference between the first refractive index and the third refractive index may be greater than a difference between the second refractive index and the third refractive index.

After that, step S111, a process of thermally fixing the preliminary optical film is performed to complete the optical film.

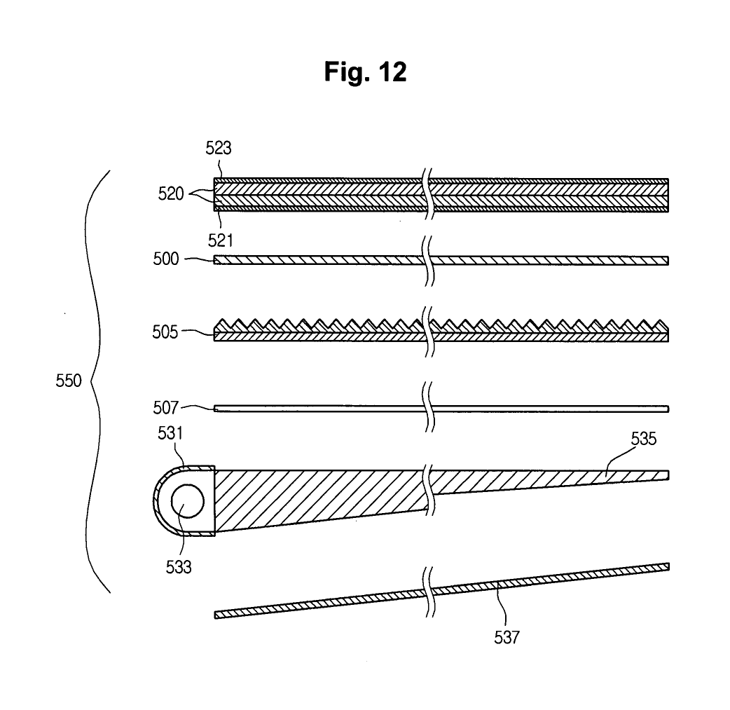

FIG. 12 shows a cross-sectional view of an LCD device according to an embodiment of the invention. Referring to FIG. 12, the LCD device includes an LC display panel 520, and a backlight assembly 550 disposed on the rear side of the LC display panel 520 to illuminate light onto the LC display panel 520. An upper polarizer 523 and a lower polarizer 521 are further provided on the upper and lower sides of the LC display panel 520.

The backlight assembly 550 includes a lamp 533 severing as a light source, a light guide plate 535 for guiding light from the lamp 533 to the LC display panel 520, and a plurality of optical sheets for improving brightness. The lamp 533 is disposed on the lateral side of the light guide plate 535. Light from the lamp 533 is incident into the light guide plate 535 through the lateral side of the light guide plate 535.

Also, a lamp reflector 531 is installed on the lateral side of the light guide plate 535 with the lamp 533 is interposed, to reflect a portion of light emitted from the lamp 533 that is not directed to the lateral side of the light guide plate 535 toward the light guide plate 535, so that light efficiency is improved.

The light guide plate 535 allows light incident from the lamp 533 to be directed to the LC display panel 520 disposed on the front side of the light guide plate 535. A variety of patterns such as fine dot patterns for directing the propagation direction of light to the LC display panel 520 are printed on the rear side of the light guide plate 535.

A reflector 537 is generally disposed below the light guide plate 535 to reflect light emitted to a rear side from the light guide plate 535 toward the light guide plate 535 and improve light efficiency.

A diffusion sheet 507, a prism sheet 505, and an optical film 500 for improving light efficiency are disposed between the light guide plate 535 and the LC display panel 520. The diffusion sheet 507 diffuses light incident from the light guide plate 535 to prevent partial concentration of light and allow light to be uniformly illuminated onto the LC display panel 520.

The prism sheet 505 includes a plurality of prism patterns having a predetermined pitch and formed on the surface of the LC display panel 520 to condense the light diffused by the diffusion sheet 507 onto the LC display panel 520 and improve front brightness.

The optical film 500 has been already described in the first to eight embodiments. A material used for forming the protection sheet can be co-extruded on one side or both sides of the multi-layered sheet to form the protection sheet without a separate adhesive member before the multi-layered sheet included in the optical film. The protection sheet is uniaxially stretched or biaxially stretched when the multi-layered sheet is stretched. The optical film 500 repeatedly reflects and transmits light incident from the light guide plate 535 to improve light efficiency and thus improve brightness of the LCD device on the whole.

For example, the optical film 500 transmits P-waves of the components of light generated from the lamp 533 to the LC display panel 510, and reflects S-waves to the light guide plate 535. Also, the S-waves reflected by the optical film 500 are reflected by a reflector disposed on the rear side of the optical film 500 back to the optical film 500. During this process, the S-waves are converted into P-waves and pass through the optical film 500 again, so that light efficiency is improved on the whole.

In an embodiment, the lower polarizer 521 has the same polarization axis direction as the vibrating direction of light, e.g., P-waves that pass through the optical film 500. Therefore, P-waves that have passed through the optical film 500 immediately pass through the lower polarizer 521 and are incident onto the LC display panel 520 and used for displaying an image. Consequently, brightness can be improved on the whole.

The backlight assembly 550 is shown in FIG. 12 as a side-type backlight unit. Although not shown, the backlight assembly 550 may be of a direct-type backlight unit and may have one or more light sources above the reflector 537 or in the same plane as the reflector 537.

Also, assuming that the same backlight power is used, light efficiency is excellent in the case where the above-described optical film is used rather than the case where the above-described optical film is not used. Therefore, backlight power can be saved.

According to an embodiment of the present invention, an optical film in which polymer layers and copolymer layers are alternately stacked is stretched in the first and second stretching directions, so that mechanical strength and a thermal durability characteristic can be enhanced.

Also, according to an embodiment of the present invention, since there is no adhesive member between a protection sheet and a multi-layered sheet, a light loss caused by the adhesive member can be reduced and entire brightness of the LCD device and an image quality are improved.

Also, since an LCD device according to an embodiment of the present invention has excellent light efficiency, backlight power can be saved.

According to an embodiment of the present invention, since a protection sheet is formed using a polymer layer or a copolymer layer constituting an optical film, affinity between the protection sheet and a multi-layered sheet increases, defects such as wrinkle generation on the film and exfoliation of the protection sheet from the multi-layered sheet are reduced.

According to an embodiment of the present invention, since a multi-layered sheet and the protection sheet are attached to each other without a separate adhesive member, a film can have a thin thickness. Also, since the multi-layered sheet and the protection sheet are integrally formed through extrusion molding, a process is simplified.

According to an embodiment of the present invention, when a polymer layer and a copolymer layer are extrusion-molded to manufacture a multi-layered sheet, molten polymer materials are formed as a protection sheet on one side of the multi-layered sheet. Therefore, foreign substances are not attached between the multi-layered sheet and the protection sheet compared to a process of attaching a separately manufactured protection sheet to the multi-layered sheet using an adhesive member. Accordingly, a defect rate is reduced.

According to an embodiment of the present invention, since a multi-layered sheet and the protection sheet are drawn together, scratch on a surface of the multi-layered sheet generated during a draw process can be prevented, and thermal damage such as surface crystallization of the surface portion of the multi-layered sheet generated during a subsequent heat treatment process is reduced, and thus quality of an optical film can be improved.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An optical film, comprising:
a multi-layer sheet including:
a plurality of polyethylene terephthalate polymer layers, the polymer layers having a first refraction index in a first direction parallel to a plane of the polymer layers and a second refraction index in a second direction parallel to the plane of the polymer layers; and
a plurality of polyethylene terephthalate copolymer layers, the copolymer layers having a third refraction index in both the first and second directions; and
a protection sheet directly on at least one side of the multi-layer sheet.

2. The optical film according to claim 1, wherein the protection sheet includes inorganic particles.

3. The optical film according to claim 2, wherein the inorganic particles include at least one of silica, titanium oxide (TiO₂) and calcium carbonate (CaCO₃).

4. The optical film according to claim 1, wherein each of the copolymer layers includes more than or equal to 50 weight % of polyethylene terephthalate (PET) and less than or equal to 50 weight % of an additive material by copolymerization.

5. The optical film according to claim 1, wherein a thickness of the protection sheet is equal to or greater than a thickness of each of the polymer layers and the copolymer layers.

6. The optical film according to claim 1, wherein the protection sheet includes at least one of polyethylene terephthalate, polytrimethylene terephthalate, polyethylene naphthalate, polyethylene terephthalate copolymer, polytrimethylene terephthalate copolymer, and polyethylene naphthalate copolymer.

7. The optical film according to claim 1, the multi-layer sheet and the protection sheet have a first draw ratio in the first stretching direction greater than a second draw ratio in the second stretching direction.

8. An optical film, comprising:
a multi-layer sheet including:
polymer layers having a first refraction index in a first direction parallel to a plane of the polymer layer and a second refraction index in a second direction parallel to the plane of the polymer layer; and
copolymer layers having a third refraction index in both the first and second directions,
wherein the polymer layers and the copolymer layers are stacked for transmitting a first component of light incident onto the multi-layer sheet and reflecting a second component of the incident light; and
a protection sheet directly on at least one side of the multi-layer sheet.

9. The optical film according to claim 8, wherein the protection sheet includes inorganic particles.

10. The optical film according to claim 9, wherein the inorganic particles include at least one of silica, titanium oxide (TiO₂) and calcium carbonate (CaCO₃).

11. The optical film according to claim 8, wherein the protection sheet includes at least one of polyethylene terephthalate, polytrimethylene terephthalate, polyethylene naphthalate, polyethylene terephthalate copolymer, polytrimethylene terephthalate copolymer, and polyethylene naphthalate copolymer.

12. The optical film according to claim 8, wherein the polymer layers include polyethylene terephthalate and the copolymer layers include polyethylene terephthalate and at least one of polytrimethylene terephthalate and polyethylene naphthalate.

13. The optical film according to claim 8, wherein the first refraction index is larger than the third refraction index, and the second refraction index is larger than the third refraction index.

14. The optical film according to claim 8, wherein a thickness of the protection sheet is equal to or greater than a thickness of each of the polymer layers and the copolymer layers.

15. The optical film according to claim 8, the multi-layer sheet and the protection sheet have a first draw ratio in the first stretching direction greater than a second draw ratio in the second stretching direction.

16. A method of fabricating an optical sheet, comprising:
preparing first, second, and third polymers;
melting and extrusion-processing each of the first, second, and third polymers in layered shape;
alternately stacking the extrusion-processed first and second polymers in a first feed block;
multiplying the number of layers of the first and second polymers in a multiplier;
stacking the third polymer directly on at least one side of the stacked first and second polymers in a second feed block; and
stretching the stacked first, second and third polymers.

17. The method according to claim 16, wherein the stretching the stacked first, second and third polymers includes stretching the stacked first, second, and third polymers in a first stretching direction and stretching the stacked first, second and third polymers in a second stretching direction.

18. The method according to claim 17, wherein the stretched first, second and third polymers have a first draw ratio in the first stretching direction greater than a second draw ratio in the second stretching direction.

19. The method according to claim 17, wherein the first stretching direction is the same direction as a movement direction of the first, second, and third polymers.

20. The method according to claim 16, wherein the first polymer includes polyethylene terephthalate, the second polymer includes polyethylene terephthalate and at least one of polytrimethylene terephthalate and polyethylene naphthalate, and the third polymer includes at least one of polyethylene terephthalate, polytrimethylene terephthalate, polyethylene naphthalate, polyethylene terephthalate copolymer, polytrimethylene terephthalate copolymer, and polyethylene naphthalate copolymer.

21. The method according to claim 16, wherein the preparing the second polymer includes mixing and copolymerizing more than or equal to 50 weight % of polyethylene terephthalate (PET) and less than or equal to 50 weight % of an additive material.

22. The method according to claim 16, wherein the preparing the third polymer includes mixing inorganic particles with at least one of polyethylene terephthalate, polytrimethylene terephthalate, polyethylene naphthalate, polyethylene terephthalate copolymer, polytrimethylene terephthalate copolymer, and polyethylene naphthalate copolymer.

23. The method according to claim 16, further comprising: thermal treating the stretched first, second and third polymers.

24. An optical film, comprising:
a multi-layer sheet including:
a plurality of polymer layers, the polymer layers including polyethylene terephthalate and having a first refraction index in a first stretching direction parallel to a plane of the polymer layers and a second refraction index in a second stretching direction parallel to the plane of the polymer layers; and
a plurality of copolymer layers, the copolymer layers including polyethylene terephthalate copolymer and having a third refraction index in both the first and second stretching directions,
a protection sheet on at least one side of the multi-layer sheet; and
an adhesive member between the multi-layer sheet and the protection sheet.

25. The optical film according to claim 24, wherein the adhesive layer has a refraction index that is substantially equal to or smaller than a refraction index of the protection sheet.

26. The optical film according to claim 24, wherein the polymer layers and the copolymer layers have a varying thickness.

27. The optical film according to claim 26, wherein the polymer layers and the copolymer layers increase in thickness as they go from outside to inside of the multi-layer sheet.

28. The optical film according to claim 26, wherein the polymer layers and the copolymer layers decrease in thickness as they go from outside to inside of the multi-layer sheet.

29. The optical film according to claim 24, wherein the polymer layers and the copolymer layers are alternately stacked.

30. The optical film according to claim 24, wherein the protection sheet includes inorganic particles.

31. The optical film according to claim 30, wherein the inorganic particles include at least one of silica, titanium oxide (TiO₂) and calcium carbonate (CaCO₃).

32. The optical film according to claim 24, wherein a thickness of the protection sheet is equal to or greater than a thickness of each of the polymer layers and the copolymer layers.

33. A liquid crystal display device, comprising:
a liquid crystal display panel for displaying images;
a reflector for reflecting light;
a backlight assembly between the reflector and the liquid crystal panel for irradiating light onto the liquid crystal display panel; and
an optical film between the backlight assembly and the liquid crystal panel, the optical film having:
a multi-layer sheet including:
a plurality of polymer layers, the polymer layers including polyethylene terephthalate and having a first refraction index in a first stretching direction parallel to a plane of the polymer layers and a second refraction index in a second stretching direction parallel to the plane of the polymer layers; and
a plurality of copolymer layers, the copolymer layers including polyethylene terephthalate copolymer and having a third refraction index in both the first and second stretching directions,
a protection sheet on at least one side of the multi-layer sheet; and
an adhesive member between the multi-layer sheet and the protection sheet.
